(19) United States
(12) Patent Application Publication
(10) Pub. No.: US 2002/0187839 A1
(43) Pub. Date: Dec. 12, 2002

(54) BEARING ARRANGEMENT OF A TWIN MASS FLYWHEELS

(76) Inventors: ALASTAIR JOHN YOUNG, WARWICKSHIRE (GB); ROBERT JOHN MURPHY, WARWICKSHIRE (GB); RICHARD DAVID MAITLAND COOKE, WARWICHSHIRE (GB)

Correspondence Address: PAUL E MILLIKEN, 9061 WALL STREET NW, MASSILLON, OH, 446461676

(21) Appl. No.: 09/194,251

(22) PCT Filed: Mar. 27, 1998
(86) PCT No.: PCT/GB98/00940

(30) Foreign Application Priority Data
Mar. 27, 1997 (GB) 9706466.1
Jul. 18, 1997 (GB) 9715027.0

(51) Int. Cl. F16D 7/02

(52) U.S. Cl. 464/45

(57) ABSTRACT

A twin mass flywheel which has an input flywheel mass (11) arranged to be coupled to an engine, an output flywheel mass (12) arranged to be coupled to a drive-line, a main rolling bearing (14) for mounting the flywheel masses for relative rotation and having inner (14B) and outer (14A) race members with rolling bearing elements therebetween, and a torsional vibration damping means (17) acting between the masses to oppose relative rotation. At least one of the bearing races is located axially relative to one of the flywheel masses by an annular retaining member (25, 29) which is secured to said one flywheel mass and engages a circumferential groove (26, 30) in the bearing race. Other bearing retaining arrangements are disclosed including the use of tapering races.

This invention relates to so-called twin mass flywheels, that is devices which comprise an input flywheel mass arranged to be coupled to an engine and an output flywheel mass arranged to be coupled to a drive line, the flywheel masses being circumferentially rotatable relative to each other against the action of torsional vibration damping means.

Examples of such devices are disclosed in granted patents GB 2229793, GB 2151332 and pending applications GB 2296072, WO96/18832.

This invention relates to various constructional arrangements for retaining rolling bearings such as a ball or roller bearing in position between the flywheel masses of a twin mass flywheel in a cheap and efficient manner and methods of assembling such arrangements. Other inventive arrangements relating to twin mass flywheels are also disclosed relating to centring of the masses of a twin mass flywheel, various details of friction damping means which act circumferentially between the masses and various aspects of rolling bearing inner or outer races.

Each of these various arrangements may be viewed as a separate inventive concept although, as will be apparent, certain of these arrangements are linked by common constructional details

Thus according to one aspect of the present invention there is provided a twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is located axially relative to one of the flywheel masses by an annular retaining member which is secured to said one flywheel mass and engages a circumferential groove in said one bearing race.

Both races may be located axially relative to a respective one of the flywheel masses by a respective annular retaining member. At least one of the annular retaining members may comprise a circlip which engages co-operating grooves in the associated race and flywheel mass. Both annular retaining members may comprise respective circlips which engage cooperating grooves in the respective associated race and flywheel mass.

At least one circlip may be retained in an annular groove in the associated flywheel mass, said groove opening into bolt holes in said associated flywheel mass to allow retraction of the circlip into said holes during assembly of the bearing on said associated flywheel mass but preventing retraction of the circlip into said holes when said bolts are in said holes thus locking the bearing to the associated flywheel mass. The bolt holes may be used to bolt an inner bearing race carrier onto the input flywheel mass and also to bolt the flywheel to the engine.

The invention also provides a method of assembling a flywheel with a circlip retaining member of the form described in the preceding paragraph, the method comprising the steps of:

locating a circlip in said annular groove;

fitting a compressing tool over said circlip to press the circlip into said bolt holes,

pressing the bearing onto the associated flywheel mass to displace said compressing tool off said circlip and allow said circlip to engage the groove in the associated bearing race to locate the bearing relative to the flywheel mass, and

inserting the bolts in the bolt holes to prevent subsequent retraction of the circlip.

The invention also provides an arrangement in which one of the annular retaining members comprises a ring-like member having a series of fingers circumferentially spaced around a periphery thereof, the fingers engaging a groove in the associated bearing race. Both retaining members may comprise such ring-like members.

In a still further alternative construction one of the retaining members may comprise a snap ring or other split annular member which engages in a groove in one of the races held against the adjacent flywheel mass by a separate plate.

The invention also provides a twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is located axially relative to one of the flywheel masses between a first separate component on one side of the race which is operatively connected with said one of the flywheel masses and a second separate component on the other side of the race which is also operatively connected with said one of the flywheel masses.

The first separate component may comprise an annular member of generally L-shaped section with a bearing retaining flange on one end of the limb of the section and the second separate component comprises a generally flat annular retaining member.

The invention also provides an arrangement in which one or both races may have an axially tapering form and may be held against a correspondingly tapering surface on the associated flywheel mass by an annular retaining member secured to the associated flywheel mass.

In a further arrangement the first separate component may comprise a hoop-shaped member which reacts against a component secured to the associated flywheel mass, one edge of the hoop-shaped member being abutted by the race and the second separate component comprises a generally flat annular retaining member.

In an alternative arrangement either or both races may have integral flanges which are held against abutments on the associated flywheel mass by an annular retaining member which is secured to the associated flywheel mass.

The invention also provides a twin mass flywheel comprising an input flywheel mass arranged to be coupled to an engine, an output flywheel mass arranged to be coupled to a drive-line, a main rolling bearing for mounting the flywheel masses of relative rotation and having inner and outer race members with rolling bearing elements therebetween, and a torsional vibration damping means acting between the masses to oppose relative rotation, the flywheel being characterised in that at least one of the bearing races is supported on a resilient tolerance ring positioned radially between the race and the associated flywheel mass.

In such a twin mass flywheel, any of the previously described bearing location arrangements may be used. The invention also provides a twin mass flywheel comprising an input flywheel mass arranged to be coupled to an engine, an output flywheel mass arranged to be coupled to a drive-line, a main rolling bearing for mounting the flywheel masses of relative rotation and having inner and outer race members with rolling bearing elements therebetween, and a torsional vibration damping means acting between the masses to oppose relative rotation, the flywheel being characterised in that a first retaining member is provided on the output flywheel mass to resist movement of the outer race away from the engine and a shoulder is provided on a bearing carrier for the inner race associated with the input flywheel mass to resist movement of the inner race towards the engine, the bearing carrier also supporting a second retaining member which is abutted by the first retaining member should there be any tendency for the output flywheel to migrate away from the engine.

In a still further arrangement where a circlip, snap ring or other annular bearing retainer is employed to retain a bearing race said race may be supported on a bearing carrier which is split axially into two parts with the circlip, snap ring or other annular retainer held captive between parts of the carrier.

The parts of the bearing carrier may be held together by bolts which also secure the input flywheel mass to the engine crankshaft or by other means such as rivets or screws or by deformation of the carrier parts themselves.

In a further alternative arrangement there is provided a twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is formed integrally with a bearing support member.

In alternative embodiments the bearing inner race or outer race may fulfil functions in addition to acting as a race against which the rolling elements run.

It will be appreciated that the circlips and other similar retaining members described in this application may be of a variety of cross-sections such as rectangular, round, tapered, trapezoidal etc. with corresponding appropriate grooves in the cooperating components.

The invention also provides an arrangement for centring the input flywheel and bearing carrier relative to each other.

In accordance with a further aspect of the present invention there is also disclosed a friction damping device which acts between the flywheel masses and which generates friction at all times whenever there is relative rotation between the masses.

The constructional arrangements of the various aspects of the present invention will now be described by way of example with reference to the accompanying drawings in which

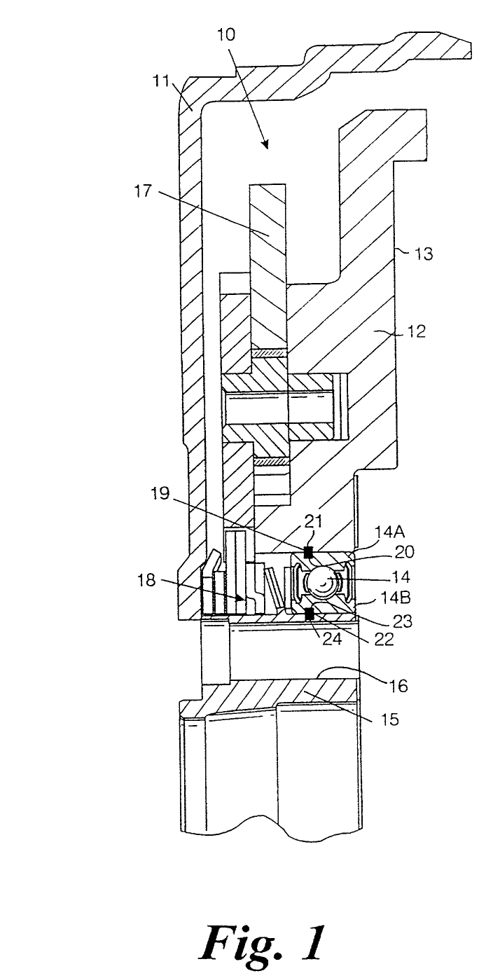

FIG. 1 is a radial half section through a twin mass flywheel incorporating a first bearing retention arrangement in accordance with the present invention, and

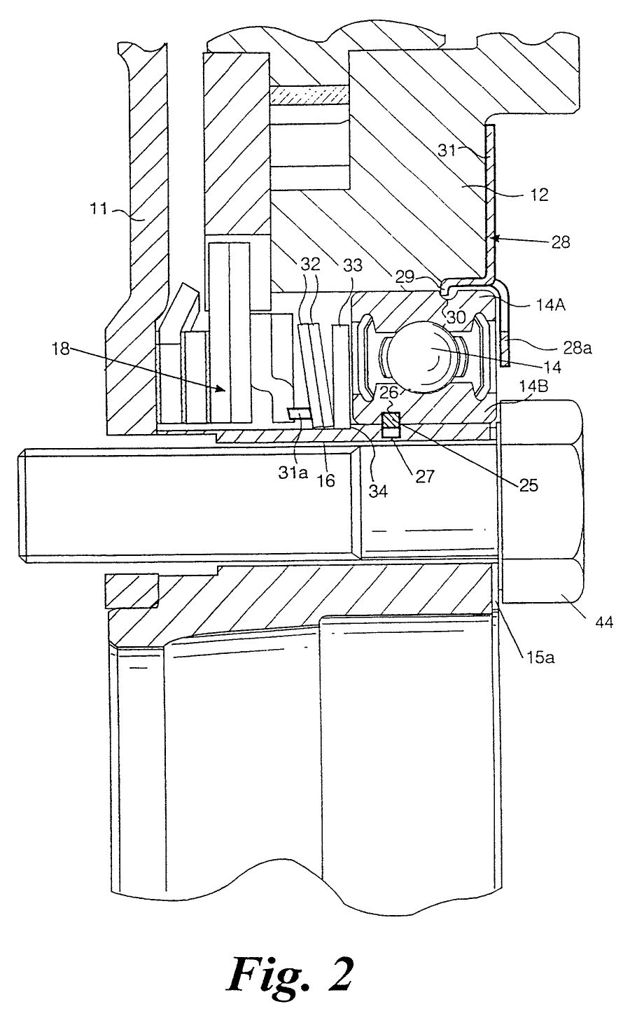

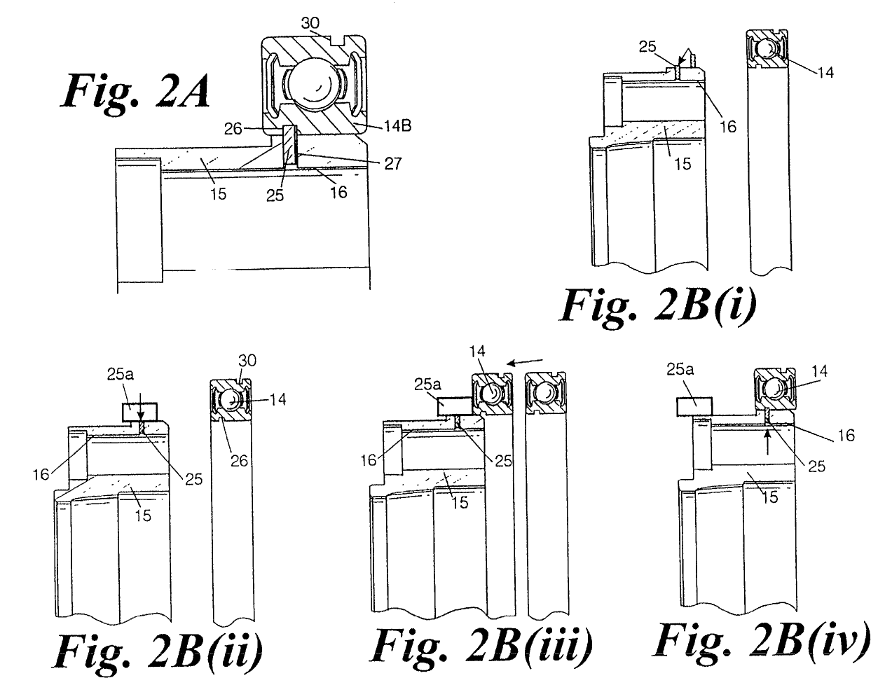

FIG. 2 shows a second bearing retention arrangement in accordance with the present invention;

FIG. 2A shows an alternative circlip groove arrangement;

FIGS. 2B(i) to 2B(iv) show stages in a method of assembling the circlip arrangement of FIG. 2A; and

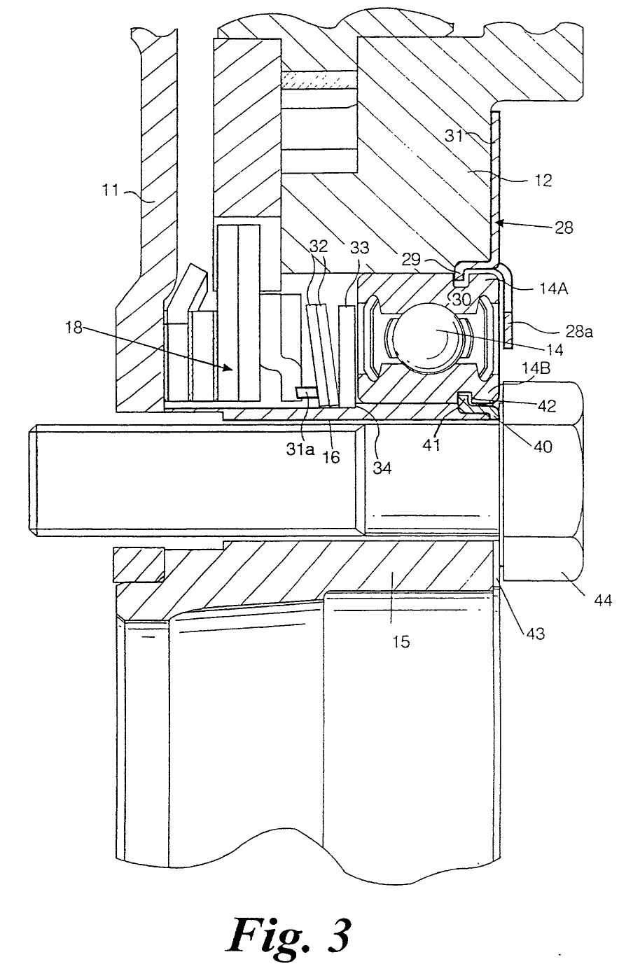

FIGS. 3 to 17 show alternative bearing retention and mounting arrangements in accordance with the present invention.

Referring to FIG. 1 this shows a twin mass flywheel 10 which includes an input flywheel mass 11 which is arranged to be connected with an engine crankshaft, an output flywheel mass 12 having a surface 13 against which a clutch driven plate (not shown) engages to connect the flywheel with an associated vehicle drive line, and a ball race bearing 14 which mounts the output flywheel mass 12 on the input flywheel mass 11 via a bearing carrier 15 which is bolted to the input mass 11 and to the crankshaft by bolts (not shown) extending through the bores 16.

In the particular example of twin mass flywheel shown the relative rotation of the input and output masses 11 and 12 is resisted by a system of bob weights 17 in the manner described, in the applicants patent no GB 2229793.

Also, in the known manner, the relative rotation of the flywheel masses may be opposed by springs (not shown in the section of FIG. 1) and by a friction damping device 18 which may be conveniently of the ramp type described in the applicants co-pending application no. WO96/29525 in which annular circumferentially spaced axially operating ramps axially displace annular friction discs into contact with each other after a given amount of relative rotation of the flywheel masses in either direction from a central position.

In accordance with the present invention the bearing 14 has its outer race 14A retained relative to the output flywheel mass 12 by a circlip 19 which engages complimentary grooves 20 and 21 in the outer race and output flywheel mass respectively.

Similarly the inner race 14B is retained relative to the bearing carrier 15 by a circlip 22 which is again engaged in cooperating grooves 23 and 24 in the inner race and bearing carrier respectively.

FIG. 2 shows an alternative bearing retention arrangement in which a circlip 25 engaged in cooperating grooves 26 and 27 in the inner race and bearing carrier 15 respectively retains the inner race 14B relative to the carrier. Bolts 44 which extend through bores 16 to secure the bearing carrier 15 and input flywheel mass 11 to the crankshaft are screwed down onto a plate 15a which protects the softer cast metal of the bearing carrier.

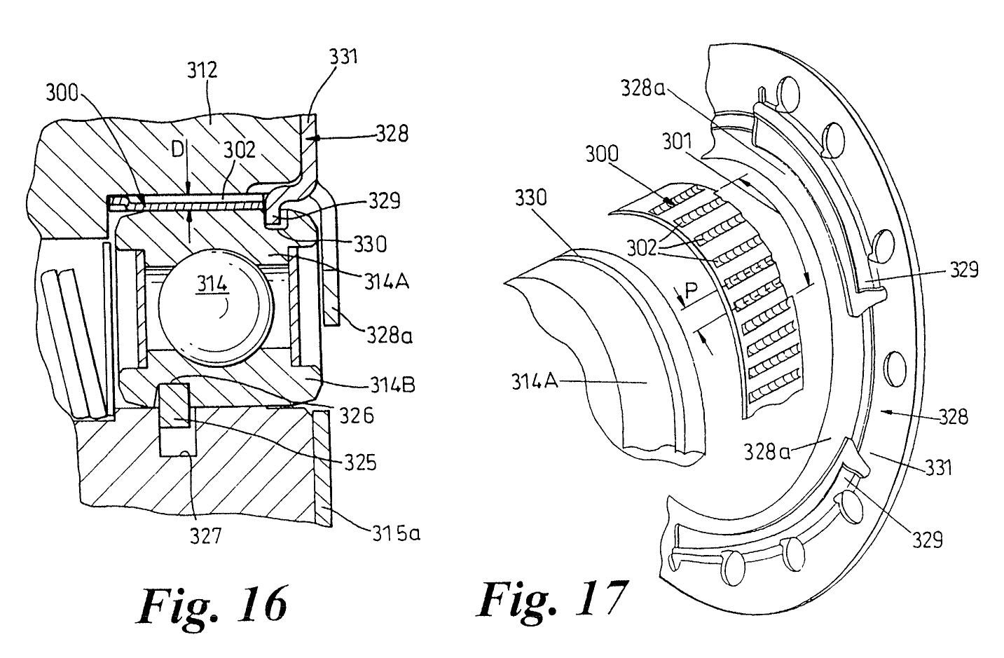

The outer race 14A is retained relative to the output flywheel mass 12 via a generally annular retaining member 28 (see also FIGS. 16 and 17 which show a similar member 228) which includes a plurality of circumferentially spaced fingers 29 around its inner peripheral zone. These fingers 29 snap into a groove 30 formed in the outer race 14A and portion 28a of member 28 protects the bearing against damage during assembly of the flywheel. The outer peripheral zone 31 of member 28 is rivetted to the output flywheel mass 12 at circumferentially spaced locations not shown in the section of FIG. 2. These rivets also serve to hold other components of the twin mass flywheel in assembled condition and the disc member 28 provides a relatively hard surface against which the rivet heads can be drawn thus protecting the softer cast construction of the output flywheel mass 12 itself.

It should also be noted, as a separate inventive concept, that the friction damping device 18 shown in FIG. 2, which is a ramp type device similar to that disclosed in WO96/29525, is provided with a light wavy washer 31a which applies axial load at all times to the plates of the friction device to ensure that frictional force is generated at all times whenever relative rotation of the flywheel masses occurs even when the device is operating in its central zone between the circumferentially spaced ramps. Also, the belleville springs 32 of the friction damping device, which act when the ramps are operational, react against an abutment member 33 which contacts a shoulder 34 on the bearing carrier 15 thus ensuring that the springs of the friction damping device do not axially load the adjacent bearing 14.

FIG. 2A shows an alternative circlip grooving arrangement for the inner race 14B in which the circlip groove 27 in the bearing carrier is designed to break through into the bores 16 through which bolts 44 extend. When the bearing is being mounted onto the carrier 15 (see FIGS. 2B(i) to 2B(iv) the circlip projects into the bores 16. Once the bolts 44 are inserted into bores 16 the circlip 25 can no longer enter bore 16 and the bearing is therefore positively locked on carrier 15.

The assembly sequence shown in FIGS. 2B(i), 2B(ii), 2B(iii) & 2B(iv) represents a separate inventive concept in which in FIG. 2B(i) the circlip 25 is located in groove 27 The circlip is then radially compressed by a tool 25a (similar to a piston ring compressing tool) as shown in FIG. 2B(ii). The bearing 14 is then pressed onto the carrier 15 as shown in FIG. 2B(iii) and displaced axially sufficiently to push tool 25a off and engage the groove 26 in the inner race 14b with the circlip as shown in FIG. 2B(iv).

FIG. 3 shows an alternative construction in which the same bearing retention arrangement is used for the outer race 14A as is shown in FIG. 2. In FIG. 3 the inner race 14B is also located relative to the bearing carrier 15 by a generally annular retaining member 40 whose radially outer peripheral portion is provided in the form of fingers 41 which snap into a groove 42 in the inner race 14B in a similar manner to the fingers 29 used to retain the outer race 14A. The inner peripheral zone 43 of the disc member 40 can be directly bolted to the bearing carrier 15 by the bolts 44 which also secure the bearing carrier and the input mass 11 to the crankshaft or may be otherwise secured to the bearing carrier intermediate the bolts 44 by rivets or other fastening means with the disc member 43 relieved around the bolts 44 so that the bolts do not clamp the disc member 42 to the bearing carrier 15.

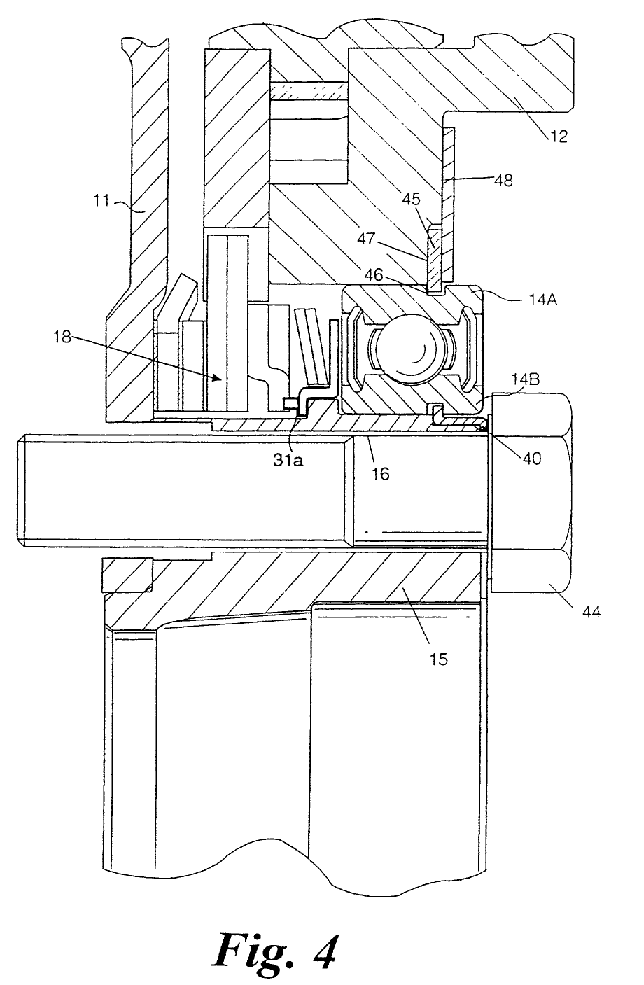

FIG. 4 shows a further alternative arrangement in which the inner race 14B is retained in exactly the same manner as described in relation to FIG. 3 above. The outer race 14A is retained by a snap-ring 45 which engages a groove 46 in the outer race and is held against a recessed shoulder 47 on the output flywheel mass 12 by an annular retaining member 48.

As previously described with relation to disc members 28 referred to above, the retaining member 48 can conveniently serve as a contacting member for rivets which not only secure the retaining member to the output flywheel mass 12 but will also hold together other components of the flywheel.

FIG. 5 shows an arrangement in which a split annular member 50 is held against the output flywheel mass 12 by a retaining member 51. The annular member 50 engages a groove 52 in the outer race 14A. The annular member 50 may either be formed in several separate parts (e.g. split on a diameter) or may be a one piece component with a radially extending slot enabling the member to be snapped into the groove 52. Again the retaining member 51 provides a surface against which to draw securing rivet heads as referred to above (or other fixing means) in relation to components 48 and 28.

The right hand end of inner race 14B abuts an annular bearing retaining member 55 which is bolted to the carrier 15 by bolts 44.

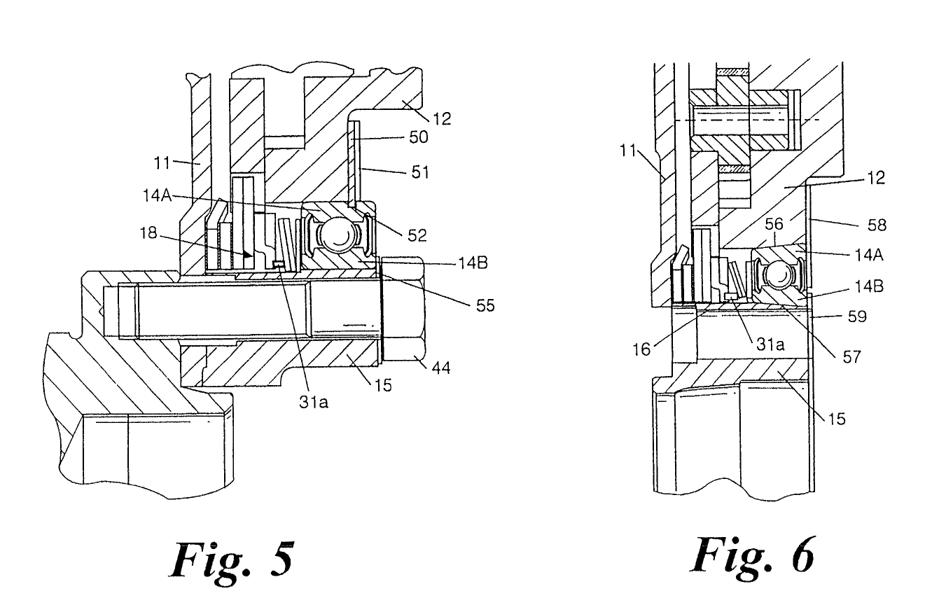

FIG. 6 shows an arrangement in which the outer and inner races 14A and 14B are tapered and are held against corresponding tapering surfaces 56 and 57 provided on the output flywheel mass 12 and bearing carrier 15 respectively. Annular retaining members 58 and 59 hold the races against the cooperating tapering surfaces. Retaining member 58 is rivetted to output flywheel mass 12 as previously described in relation to components 28 and 48 and retaining member 29 may be held in position by the main attachment bolts 44 as described above, or completely separately by rivetting or other means which secure this member to the bearing carrier 15.

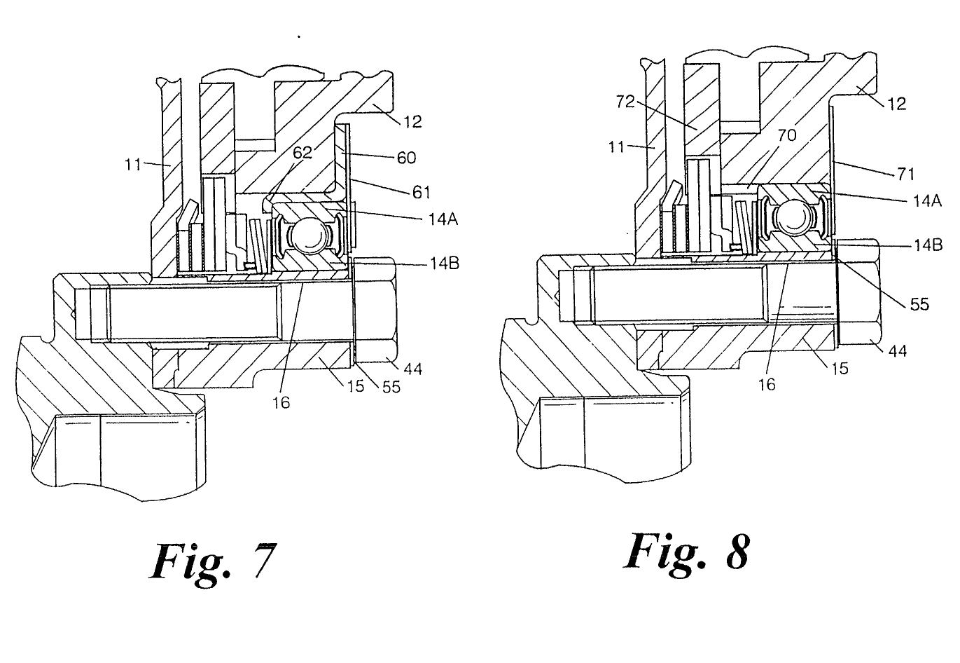

In the arrangement shown in FIG. 7 the inner race 14B is secured to the carrier in the same manner as described with reference to FIG. 5. The outer race 14A is secured to the output flywheel mass 12 between a pressed generally annular member 60 of generally L-shaped section with a bearing retaining flange 62 on one end of one limb of the section and a cooperating generally flat retaining member 61. Both members 60 and 61 are again rivetted to output flywheel 12 in the manner previously described with reference to component 28, 48 and 58 above.

FIG. 8 shows a further alternative arrangement in which the inner race 14B is secured to the carrier 15 in the same manner as described above in relation to FIGS. 5 and 7 and the outer race 14A is secured to the output flywheel mass 12 between a hoop-shaped member 70 and a retaining member 71 which is rivetted to the output mass 12. The hoop-shaped member 70 is in turn held between the outer race 14A and a component 72 which is also secured to the output flywheel mass 12. Component 72 not only serves to non-rotatably connect parts of the friction damping device 18 to the output flywheel mass 12 but also provides a reaction member for generally circumferentially acting springs which form part of the torsional vibration damping means which acts between the flywheel masses. Thus both the outer race 14A and the hoop-shaped member 70 are confined between components 71 and 72.

In the arrangement shown in FIG. 9 both the outer and inner races 14A and 14B are provided with integral flanges 80 and 81 respectively which are held against abutments 82 and 83 on the output flywheel mass 12 and bearing carrier 15 by retaining plate 84 and 85 respectively. As in previous described constructions the retaining member 84 is rivetted to the output flywheel mass 12 and the retaining member 85 may be held on the carrier solely by the bolts 44 or completely independently thereof by additional fastening means such as rivets positioned circumferentially between the bolts 44.

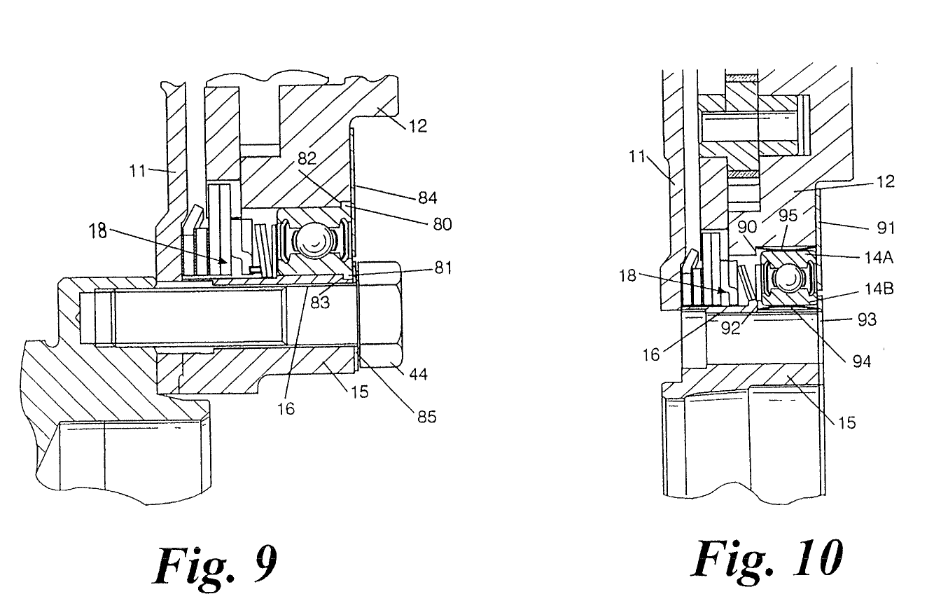

FIG. 10 shows an arrangement in which the outer race 14A is held captive between an abutment 90 on the output flywheel mass 12 and a retaining member 91 which is rivetted to the output flywheel mass as previously described in relation to component 84. The inner race 14B is similarly located between an abutment 92 on the bearing carrier 15 and a retaining member 93 which may be secured in position either by bolts 44 as previously described or by completely independent fastening means.

Inboard of inner race 14B and outboard of outer race 14A two annular and slightly resilient corrugated tolerance rings 94 and 95 are located which support the bearing races against radial movement relative to the bearing carrier 15 and output flywheel mass 12 respectively. Use of these tolerance rings enables the radial surfaces against which the bearing races are supported to be manufactured to a lower level of manufacturing tolerance thus reducing the cost of production of the twin mass flywheel. The tolerance rings 94 and 95 are sufficiently radially resilient to accommodate flexing of the engine crankshaft which results in tilting of the input mass 11 relative to the output mass 12 during use of the flywheel.

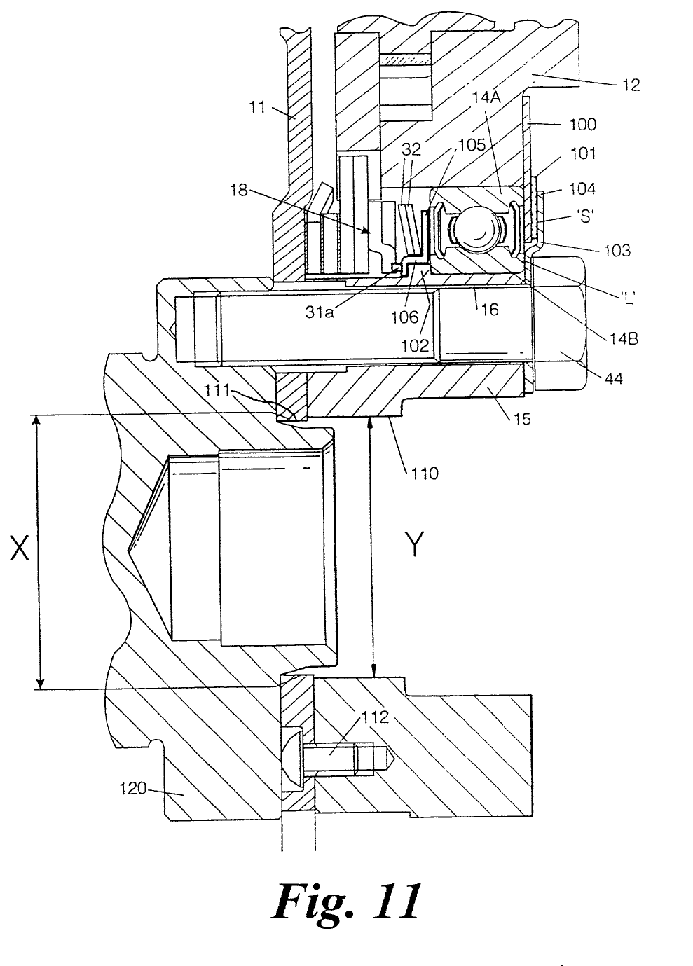

FIG. 11 (which includes crankshaft 120) shows an arrangement in which the outer race 14A is held against movement to the right (as viewed in FIG. 11) relative to output flywheel mass 12 by a first annular retaining member 100 which is rivetted or otherwise secured to output flywheel mass 12 as previously described above with reference to previous constructions. On the outside of retaining plate 100 is an annular plastics wear pad or layer 101.

The inner race 14B is supported at its left hand end against an abutment 102 provided on the carrier 15. A second annular retaining member 103 is provided at the right hand end of inner race 14B. This retaining member is held on the bearing support 15 by retaining bolts 44 and is spaced from the right hand end of inner race 14B by a distance L. The retaining member 103 has a radially outer portion 104 which overlaps the wear pad 101 and is spaced therefrom by a clearance S which is smaller than clearance L.

Any tendency of output flywheel mass 12 to migrate to the right, as viewed in FIG. 11, during operation of the flywheel will result in the wear pad 101 contacting the axially inner surface of portion 104 of retaining member 103 thus arresting axial movement of the outer flywheel mass. At no time will the right hand end of inner bearing race 14B make contact with the bearing retaining member 103 since clearance L is significantly larger than clearance S referred to above.

FIG. 11 also shows an arrangement in which the belleville springs 32 of the friction damping device 18 react against a sheet metal member 105 which has circumferentially spaced tabs 106 around its inner periphery which react against the abutment 102.

During assembly of the flywheel a spigot on the assembly jig engages the bore 110 of bearing carrier 15 which has an accurately machined diameter Y. The input flywheel mass 11 is then centred-relative to bore 110 using central bore 111 which has an accurately machined diameter X Diameter X (which ultimately centres the twin mass flywheel relative to the crankshaft) is smaller then diameter Y. Once the concentricity of input flywheel 11 and bearing support 15 is established they are secured together by pan head screws 112 or other fastening means such as dowels, roll pins or the like and may additionally be glued together using LOCTITE or other proprietary adhesive

Subsequently it is then possible to turn the sub-assembly of the input flywheel 11 and bearing support 15 over and relocate it on the same jig using the same diameter Y and perform further operations as required to produce a finished twin mass flywheel. This can be particularly beneficial during automatic assembly of the twin mass flywheel.

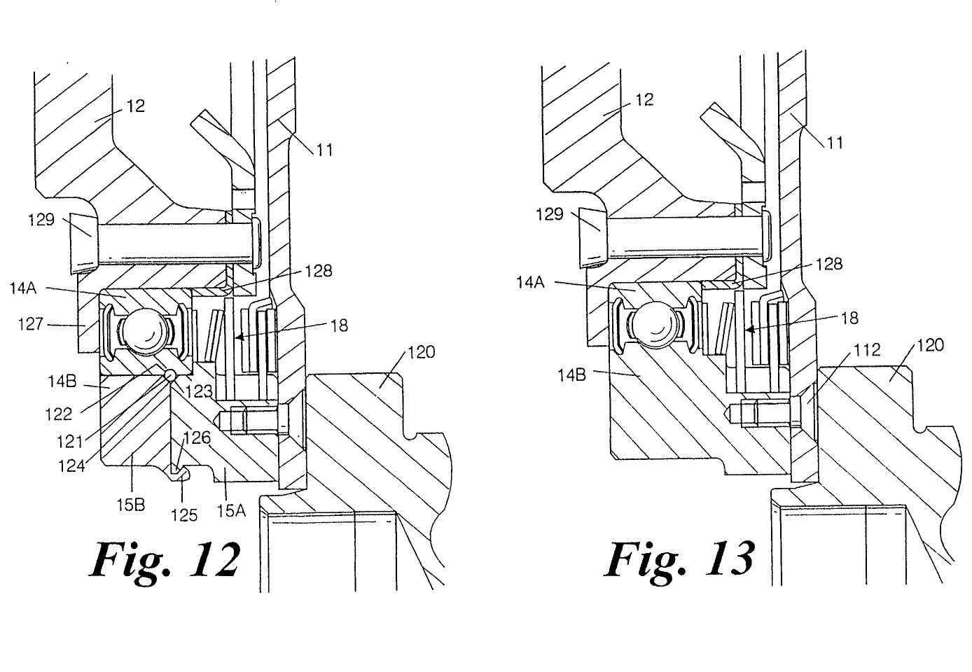

FIG. 12 shows an arrangement in which the bearing carrier 15 is in two parts 15A and 15B which are both secured to the crankshaft 120 by bolts (not visible in FIG. 12) which extend axially through both bearing support parts. The inner race 14B is held captive on the bearing supports by a circular cross section split ring 121 which engages a groove 122 in the inner race 14B and a V cross section notched formed by bevelling the corners 123 and 124 of support parts 15A and 15B respectively. The two parts of the bearing support are also held permanently together by deformation of portion 125 of part 15B over a ridge 126 formed on part 15A.

The outer race 14A is held at its left hand end against an abutment 127 of flywheel mass 12 and at its right hand end by a generally L-shaped annular retaining member 128 which is secured to the output flywheel mass 12 by rivet 129.

It will be appreciated that the cross-section of split ring 121 may not necessarily be circular but could be rectangular or tapered etc with corresponding formations provided in the inner race 14B and the support parts 15A and 15B. Also the parts 15A and 15B of the support could be held together solely by the main bolts which secure bearing support to crankshaft 120.

In FIG. 13 the outer race 14A is retained in the same manner as described in relation to FIG. 12 and the inner race 14B is made integral with the previously described bearing support member 15 and is then secured to the crankshaft 120 by the previously described main mounting bolts.

In alternative embodiments the bearing inner race or outer race may fulfil functions in addition to acting as a race against which the rolling elements run and this represents a separate inventive concept. For example, the inner or outer race may fulfil any one or more of the following functions i.e. they may:

1) act as support for components of a friction device eg. act to support a friction ring or a resilient means such as a belleville spring (see FIG. 13);

2) act to take torque drive from a component of a friction device (see FIG. 13);

3) act as a friction surface of an adjacent friction device,

4) have attachment through holes or blind holes for attaching means such as the screw 112 in FIG. 13 or crankshaft bolts or clutch cover bolts, which are utilised to fix the race to an adjacent component;

5) act to radially centralise, relative to itself a part of the associated input or output flywheel which it is rotationally fast with (e.g. it could have a locating diameter against which the flange 11 of FIG. 13 locates);

6) act to centralise the twin mass flywheel relative to an associated engine output shaft;

7) include specific features for use in automated assembly e.g. automated assembly of the bearing onto another component of the twin mass flywheel or automated assembly of the twin mass flywheel onto an associated engine output shaft;

8) include cooling holes for the passage of cooling air;

9) act as a spacer to ensure the thickness of the flywheel as a whole, in regions local to fixing means such as crankshaft bolts, is of the correct dimensions (see FIG. 13);

10) act as a hardened surface in order to withstand local loads from fixing means such as rivets, bolts or screws [see FIG. 13 in respect of crankshaft bolts (not shown];

11) provide material for joining the race to another component e.g. by spinning or peening a portion of the race. For example, the portion 125 of the bearing carrier of FIG. 12 could be similarly utilised on the integral bearing carrier/inner race of FIG. 13;

12) provide a surface for gluing the race to another component (e.g. the interface between inner race 14B and flywheel 11 of FIG. 13), and

13) provide a surface for identification of an assembly or a sub-assembly of which the bearing forms a part.

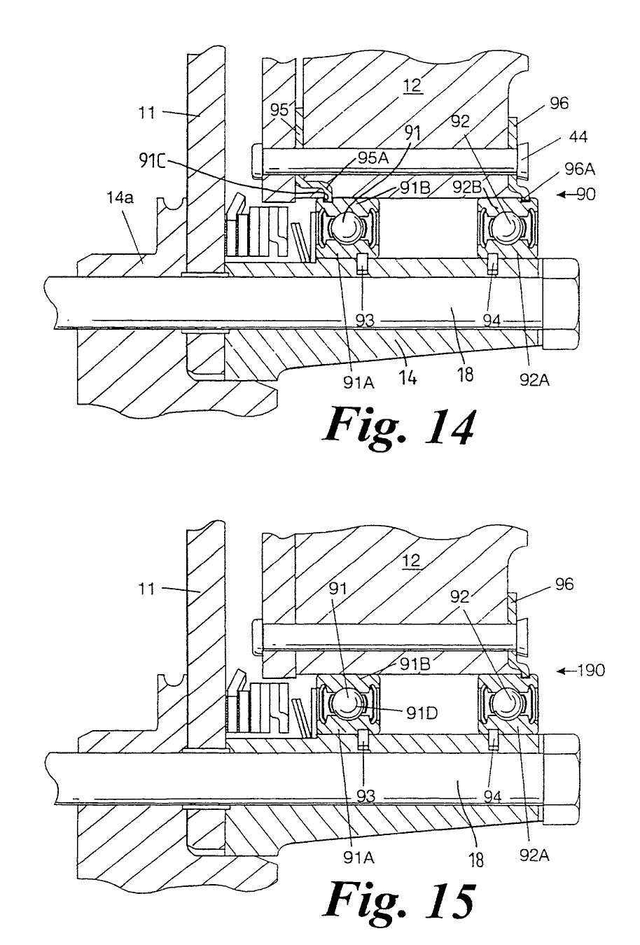

FIG. 14 shows part of a larger size commercial vehicle bob weight type twin mass flywheel in which an output mass 12 is supported relative to an input mass 11 via a bearing arrangement 90 comprising a pair of axially spaced bearings 91 and 92.

The inner race 91A, 92A of each bearing is axially located by a snap ring or circlip 93, 94 on a split central bearing support hub 14, 14a which is secured together with input mass 11 to the crankshaft (not shown) of the associated engine via bolts 18. The outer race 91B, 92B of each bearing is located by a plate 95, 96. Plate 95 is generally annular in shape and is secured to mass 12 together with plate 96 by rivets 44. Plate 95 has three circumferentially separated arcuate radially inner portions 95A (only one shown) (all of which are axially displaced from the main annular portion of the plate 95) and which can be snapped into the groove 91C of bearing outer race 91B to secure the bearing 91 axially relative to the flywheel mass 20. Plate 96 is similar to plate 95 but has a smaller axial displacement of inner portions 96A.

In a simplification of the arrangement shown in FIG. 14 any one of snap rings 93 or 94 or plates 95 or 96 could be deleted and the axial location of the flywheel masses 11 and 12 and bearings 91 and 92 would still be ensured. For example, in the bearing arrangement 190 of FIG. 15, the plate 95 is absent but the axial location of flywheel mass 11 relative to flywheel mass 12 is still ensured by bearing 92, plate 96 and snap ring 94. The axial location of bearing 91 is ensured by snap ring 93. The axial location of bearing outer race 91B being ensured by the balls 91D

FIGS. 16 and 17 show a further bearing arrangement, basically similar to that shown in FIG. 2 with similar components numbered 300 higher, which uses a corrugated metal tolerance ring 300 located between outer bearing race 314A and the associated output flywheel mass 312. This tolerance ring arrangement again, as in the arrangement shown in FIG. 10, reduces costs and accommodates flexing of the engine crankshaft which results in the tilting of the input flywheel mass relative to the output mass. The fingers 329 of retaining member 328 extend through edge slots 301 in tolerance ring 300 and engage groove 330 in outer race 314A.

In certain applications it may be desirable to combine parts of the retaining member 328 with the tolerance ring 300, for example fingers 329 may be formed along one edge of tolerance ring 300 and/or flange 331 formed along the other edge. Typically in a tolerance ring of a nominal 115 mm diameter the pitch P of the individual corrugations 302 is 6.30 mm, the thickness of the metal is 0.5 mm and the total depth ‘D’ of the ring before installation is 1.25 mm. This depth ‘D’ is typically designed to be reduced by 0.225 mm when installed to provide an inherent spring force in the tolerance ring.

Tolerance rings can be used singularly at either of the peripheries of the bearing or at both peripheries, as shown in FIG. 10.

The closed ends of the corrugations 302 contribute greatly to the stiffness and stability of the tolerance ring. In certain applications open-ended corrugations may be required to give the tolerance ring greater compliance.

It will be appreciated that the various constructional arrangements described above are applicable to all types of twin mass flywheels no matter whether the relative rotation of the flywheel masses is resisted by bob weights, springs, elastomeric material, viscous medium, friction or a combination of the above.

1. A twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is located axially relative to one of the flywheel masses by an annular retaining member which is secured to said one flywheel mass and engages a circumferential groove in said one bearing race.

2. A flywheel according to claim 1 characterised in that both races are located axially relative to a respective one of the flywheel masses by a respective annular retaining member.

3. A flywheel according to claim 1 or 2 characterised in that at least one of the annular retaining members comprises a circlip which engages corporating grooves in the associated race and flywheel mass.

4. A flywheel according to claim 3 characterised in that both annular retaining members comprise respective circlips which engage cooperating grooves in the respective associated race and flywheel mass.

5. A flywheel according to claim 3 or 4 characterised in that at least one circlip is retained in an annular groove in the associated flywheel mass, said groove opening into bolt holes in said associated flywheel mass to allow retraction of the circlip into said holes during assembly of the bearing on said associated flywheel mass but preventing retraction of the circlip into said holes when said bolts are in said holes thus locking the bearing to the associated flywheel mass.

6. A flywheel according to claim 5 characterised in that said bolt holes are used to bolt an inner bearing race carrier onto the input flywheel mass and also bolt the flywheel to the engine.

7. A method of assembling a flywheel according to claims 5 or 6 comprising the steps of:
locating a circlip in said annular groove;
fitting a compressing tool over said circlip to press the circlip into said bolt holes;
pressing the bearing onto the associated flywheel mass to displace said compressing tool off said circlip and allow said circlip to engage the groove in the associated bearing race to locate the bearing relative to the flywheel mass, and
inserting the bolts in the bolt holes to prevent subsequent retraction of the circlip.

8. A flywheel according to any one of claims 1 to 3 characterised in that one of the annular retaining members comprises a ring-like member having a series of fingers circumferentially spaced around a periphery thereof, the fingers engaging a groove in the associated bearing race.

9. A flywheel according to claim 8 characterised in that both annular retaining members comprise separate ring-like members each having a series of fingers circumferentially spaced around a periphery thereof, the fingers engaging a groove in the respective associated bearing race.

10. A flywheel according to any one of claims 1 to 3 characterised in that one of the annular retaining members comprises a snap ring or other split annular member which engages a groove in one of the races and is held against the associated flywheel by a separate plate.

11. A flywheel according to claim 10 characterised in that the split annular member is formed as several separate parts

12. A twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is located axially relative to one of the flywheel masses between a first separate component on one side of the race which is operatively connected with said one of the flywheel masses and a second separate component on the other side of the race which is also operatively connected with said one of the flywheel masses.

13. A flywheel mass according to claim 12 characterised in that the first separate component comprises an annular member of generally L-shaped section with a bearing retaining flange on one end of the limb of the section and the second separate component comprises a generally flat annular retaining member.

14. A flywheel according to claim 12 characterised in that the first separate component comprises a hoop-shaped member which reacts against a component secured to the associated flywheel mass, one edge of the hoop-shaped member being abutted by the race and the second separate component comprises a generally flat annular retaining member.

15. A twin mass flywheel comprising an input flywheel mass arranged to be coupled to an engine, an output flywheel mass arranged to be coupled to a drive-line, a main rolling bearing for mounting the flywheel masses of relative rotation and having inner and outer race members with rolling bearing elements therebetween, and a torsional vibration damping means acting between the masses to oppose relative rotation, the flywheel being characterised in that at least one of the bearing races is of axially tapering form and is held against a correspondingly tapering surface on the associated flywheel mass by an annular retaining member which is secured to the associated flywheel mass.

16. A twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is provided with an integral flange which is held against an abutment on the associated flywheel mass by an annular retaining member which is secured to the associated flywheel mass.

17. A twin mass flywheel comprising an input flywheel mass arranged to be coupled to an engine, an output flywheel mass arranged to be coupled to a drive-line, a main rolling bearing for mounting the flywheel masses of relative rotation and having inner and outer race members with rolling bearing elements therebetween, and a torsional vibration damping means acting between the masses to oppose relative rotation, the flywheel being characterised in that at least one of the bearing races is supported on a resilient tolerance ring positioned radially between the race and the associated flywheel mass.

18. A flywheel according to claim 17 characterised in that said at least one race is held axially by any of the previously claimed bearing locations arrangements.

19. A twin mass flywheel comprising an input flywheel mass arranged to be coupled to an engine, an output flywheel mass arranged to be coupled to a drive-line, a main rolling bearing for mounting the flywheel masses of relative rotation and having inner and outer race members with rolling bearing elements therebetween, and a torsional vibration damping means acting between the masses to oppose relative rotation, the flywheel being characterised in that a first retaining member is provided on the output flywheel mass to resist movement of the outer race away from the engine and a shoulder is provided on a bearing carrier for the inner race associated with the input flywheel mass to resist movement of the inner race towards the engine, the bearing carrier also supporting a second retaining member which is abutted by the first retaining member should there be any tendency for the output flywheel to migrate away from the engine.

20. A twin mass flywheel according to any preceding claim which utilises a circlip, snap ring or other annular retainer characterised in that at least one of the races is supported on a bearing carrier which is split axially into two parts with the circlip, snap ring or other annular retainer held captive between parts of the carrier.

21. A flywheel according to claim 20 characterised in that the parts of the bearing carrier are held together by bolts which also secure the input flywheel mass to the engine.

22. A flywheel according to claim 20 characterised in that the parts of the bearing carrier are held together by rivets, screws or other fasteners or by deformation of the carrier parts themselves.

23. A twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that at least one of the bearing races is formed integrally with a bearing support member.

24. A flywheel according to claim 23 characterised in that the inner or outer race fulfils at least one function in addition to acting as a race against which the rolling elements run

25. A flywheel according to claim 24 characterised in that the inner or outer race acts as a support for components of a friction device which acts between the flywheel masses.

26. A twin mass flywheel comprising an input flywheel mass arranged to be coupled to an engine, an output flywheel mass arranged to be coupled to a drive-line, bearings means for mounting the flywheel the flywheel masses for relative rotation, and a torsional vibration damping means acting between the masses to oppose relative rotation, the flywheel being characterised in that the bearing means comprises two axially spaced rolling bearings.

27. A flywheel according to claim 26 characterised in that each axially spaced rolling bearing comprises inner and outer races with rolling bearing elements therebetween and at least one of the bearings is located relative to its associated flywheel mass by a retaining arrangement in accordance with any one of claims 1 to 22 above.

28. A flywheel according to claim 27 characterised in that each race of each bearing is located relative to its associated flywheel mass.

29. A flywheel according to claim 27 characterised in that only three of the races of the two bearings are located relative to their associated flywheel masses.

30. A twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that the torsional vibration damping means includes a friction damping device comprising friction discs operatively connected with the flywheel masses which are axially biased into contact at all times to ensure the generation of a frictional damping force at all times.

31. A flywheel according to claim 30 characterised in that the friction discs are biased into contact by a spring means which reacts against a shoulder on a carrier for one of the bearing races.

32. A twin mass flywheel comprising an input flywheel mass arranged to be coupled to an engine, an output flywheel mass arranged to be coupled to a drive-line, a main rolling bearing for mounting the flywheel masses for relative rotation and having inner and outer race members with rolling bearing elements therebetween, and a torsional vibration damping means acting between the masses to oppose relative rotation, the flywheel being characterised in that the torsional vibration damping device includes a friction damping device comprising friction discs operatively connected with the flywheel masses which are axially biased into frictional contact by a spring means which reacts against a shoulder on a carrier for one of the bearing races.

33. A flywheel according to claim 31 or 32 characterised in that the spring means reacts against a plate which abuts the shoulder on the bearing carrier.

34. A flywheel according to claim 33 characterised in that the spring means comprises one or more belleville springs.

35. A flywheel according to claim 34 characterised in that the friction damping device includes circumferentially spaced axially operating ramps which axially displace the friction discs into contact after a given amount of relative rotational movement of the flywheel masses from a central position and in that the spring means also comprises a further axially acting spring device which axially loads the friction discs to generate friction when the friction damping device is operating in a central zone adjacent the central position and the belleville springs and ramps are not operative.

36. A twin mass flywheel constructed and arranged substantially as hereinbefore described with reference to and as shown in any one of the accompanying drawings.
